(19) United States
(12) Patent Application Publication
(10) Pub. No.: US 2021/0399364 A1
(43) Pub. Date: Dec. 23, 2021

(54) LIQUID-PROOF METAL-AIR ELECTRODE COMPONENT AND METAL-AIR CELL

(71) Applicant: Shenzhen Shengtong New Energy Technology Co., Ltd., Shenzhen (CN)

(72) Inventors: Wudai Hou, Kunming (CN); Xuebing Kuang, Yiyang (CN)

(21) Appl. No.: 17/446,614

(22) Filed: Aug. 31, 2021

(51) Int. Cl. H01M 12/02; H01M 12/06

(52) U.S. Cl. CPC H01M 12/02; H01M 12/06

(57) ABSTRACT

The utility model provides a liquid-proof metal-air electrode component and a metal-air cell. The liquid-proof metal-air electrode component comprises: a plastic bottom shell, an air electrode and a metal electrode, wherein the metal electrode and the air electrode are respectively provided on the back surface and the front surface of the plastic bottom shell, the metal electrode is fixed to the plastic bottom shell, and the periphery of the air electrode is encapsulated in the plastic bottom shell. The utility model further provides a metal-air cell using the liquid-proof metal-air electrode component.

### TECHNICAL FIELD

The utility model belongs to the field of a metal-air cell, and in particular, relates to a liquid-proof metal-air electrode component and a metal-air cell.

### BACKGROUND

A metal-air cell is a fuel cell of a new concept formed by replacing hydrogen energy with metal fuel, and is expected to become a new generation of green energy. The metal-air cell exploits many advantages of a fuel cell, provides zinc, aluminum and other metals to the reaction position in the cell like hydrogen, and forms a continuous power generation device together with oxygen, with the advantages of being non-toxic, non-polluting, stable in discharge voltage, high in specific energy, low in internal resistance, long in storage life, relatively low in price, low in process technology requirements, high in specific power, etc. The metal-air cell is rich in cheap resources and renewable, and simpler than a hydrogen fuel cell structure. The metal-air cell is a new energy with promising development and application.

However, because the metal-air cell uses a metal salt solution as the ionic conductor, the metal salt solution is highly corrosive to the metal parts in the electrode component; after prolonged use, it is very easy to result in the problem of metal salt solution leakage in the electrode component due to corrosion of the metal parts.

### SUMMARY

In view of the above problem existing in the prior art, the utility model provides a liquid-proof metal-air electrode component and a metal-air cell.

In order to achieve the above object, the utility model provides the following technical solution: a liquid-proof metal-air electrode component, comprising: a plastic bottom shell, an air electrode and a metal electrode, wherein the metal electrode and the air electrode are respectively provided on the back surface and the front surface of the plastic bottom shell, the metal electrode is fixed to the plastic bottom shell, and the periphery of the air electrode is encapsulated in the plastic bottom shell.

Preferably, the periphery of the air electrode is encapsulated in the plastic bottom shell through an injection molding process; a plastic middle frame for encapsulating the air electrode is formed in the injection molding encapsulating process, the plastic middle frame and the plastic bottom shell are integrated, and the plastic middle frame and the plastic bottom shell cooperate with each other to achieve the injection molding edge sealing structure of the air electrode.

Preferably, the air electrode comprises an air electrode body and a conductive side extending from the air electrode body, the metal-air electrode component further comprises a conductive sheet, which is in electric contact with the conductive side; both the conductive side and the conductive sheet are encapsulated in the plastic bottom shell.

Preferably, the metal-air electrode component further comprises a first conductive bolt and a second conductive bolt, the first conductive bolt extends into the plastic bottom shell to be in electric contact with the conductive sheet; and the metal electrode is fixed to the plastic bottom shell through a second conductive bolt.

Preferably, a sealing contact is formed between the first conductive bolt and the hole wall of the mounting hole in the plastic bottom shell; the second conductive bolt is sealed and fixed with the plastic bottom shell through a plastic gasket.

Preferably, the liquid-proof metal-air electrode component further comprises a first conductive elastic pin and a second conductive elastic pin used as output electrodes, respectively, wherein the first conductive elastic pin and the second conductive elastic pin are electrically connected to the first conductive bolt and the second conductive bolt through conductive foam, respectively.

Preferably, the liquid-proof metal-air electrode component further comprises a plastic surface shell, wherein the plastic surface shell covers the front surface of the plastic bottom shell, the surface shell is provided with a hollow area at the position corresponding to the air electrode, and the first conductive elastic pin and the second conductive elastic pin extend out of the plastic surface shell.

A metal-air cell, comprising: a liquid container, and a metal-air electrode component mounted on the liquid container, wherein the metal-air electrode component is a liquid-proof metal-air electrode component as described above, after pouring the liquid into the liquid container, the metal electrode of the metal-air electrode component is immersed in the liquid of the liquid container.

The beneficial effects of the utility model are as follows.

In the liquid-proof metal-air electrode component, the advantage of using an injection molding process to encapsulate the air electrode is that: an injection molding edge sealing is formed on the periphery of the air electrode, which ensures the sealing performance between the air electrode and the plastic bottom shell, and compared with the fixing method using screws and other fixing parts, it has better sealing performance and product consistency, thereby reducing product defect rate and improving product performance.

In addition, the air electrode in the metal-air electrode component has a two-layer sealing structure:

a first layer of sealing structure: the periphery of the air electrode is encapsulated in the annular hollow area of the plastic bottom shell through an injection molding process;

a second layer of sealing structure: a sealing contact is formed between the first conductive bolt and the hole wall of the mounting hole in the plastic bottom shell. The cooperation of the two-layer sealing structure can ensure an excellent sealing effect between the air electrode and the plastic bottom shell, reduce the possibility of solution leakage, and enable the metal-air electrode component to have higher reliability.

### BRIEF DESCRIPTION OF THE DRAWINGS

In order to more clearly explain the technical solutions in the embodiments of the utility model, the drawings required for the description of the embodiments will be briefly introduced below. Obviously, the drawings in the following description are only some embodiments of the utility model. For those skilled in the art, other drawings can be obtained based on these drawings without paying creative labor, in which:

FIG. 1 is a schematic structural diagram of a metal-air cell according to an embodiment of the utility model;

FIGS. 2 and 3 are perspective diagrams of a metal-air electrode component in a metal-air cell shown in FIG. 1;

FIG. 4 is an exploded diagram of a metal-air electrode component shown in FIGS. 2 and 3;

FIG. 5 is a schematic structural diagram of an air electrode, a conductive sheet and a plastic middle frame in a metal-air electrode component shown in FIGS. 2 and 3.

### DESCRIPTION OF THE EMBODIMENTS

The technical solutions in the embodiments of the utility model will be described clearly and completely below. Obviously, the described embodiments are only some embodiments of the utility model, rather than all the embodiments. Based on the embodiments of the utility model, all other embodiments obtained by those skilled in the art without paying creative labor shall fall within the protection scope of the utility model.

In the claims, description and drawings of the utility model, unless expressly defined otherwise, the terms such as “first”, “second”, or “third” are used to distinguish different objects, rather than describe a specific order.

Metal-air cell is a chemical cell that releases electric energy through electrochemical reaction, which comprises a metal anode made of active metal, an air cathode made of oxygen in air as an active substance, and a metal salt solution as an ion conductor, wherein both the metal anode and the air cathode are in contact with the metal salt solution and conduct ions through the metal salt solution. The metal anode can be made of any metal with negative electrode potential such as magnesium, aluminum, zinc, mercury and iron, which is not limited by the utility model.

The working principle of metal-air cell is as follows.

During the discharge process, the metal anode loses electrons for oxidation reaction and releases metal ions into the metal salt solution, and the air cathode obtains electrons for reduction reaction, thus converting chemical energy into electric energy.

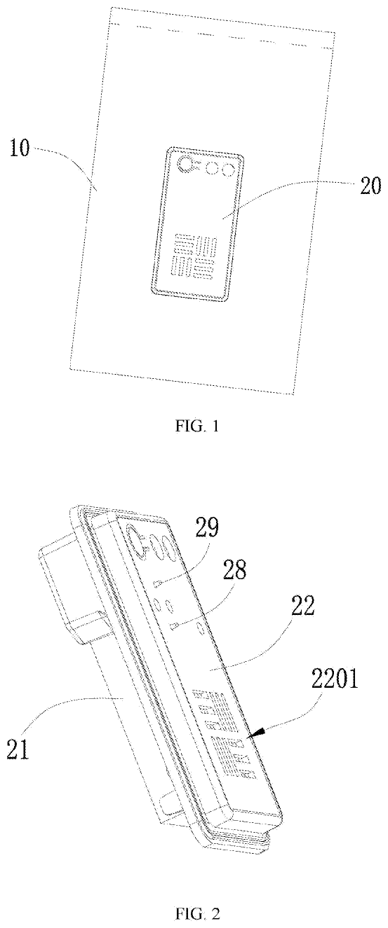

As shown in FIG. 1, this embodiment provides a metal-air cell comprising: a liquid container 10 and a metal-air electrode component 20 mounted on the liquid container 10. The liquid container 10 is used to contain metal salt solution of an ion conductor. In this embodiment, the liquid container 10 is a bag-type container. Of course, it is not limited to this embodiment, and the liquid container 10 may also be other suitable containers, as long as it can meet the requirements of the liquid container of the metal-air cell.

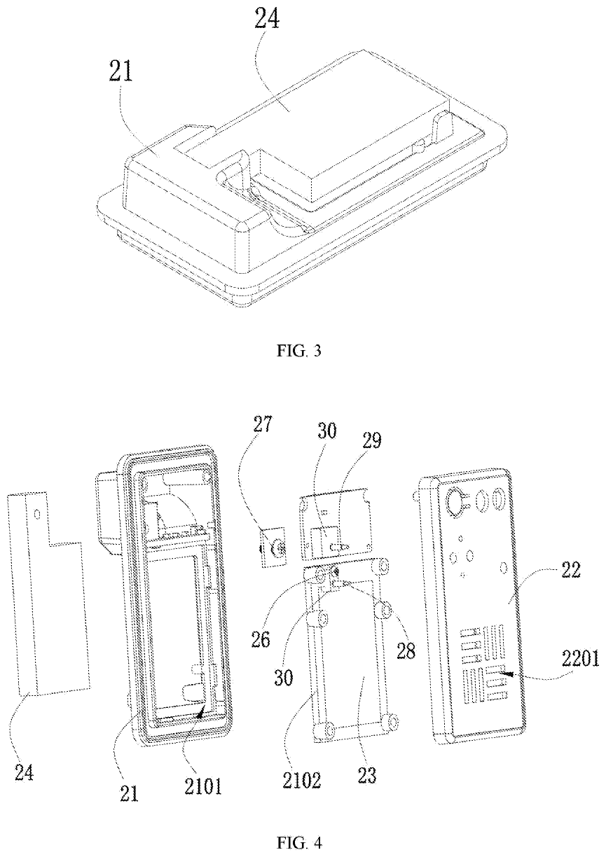

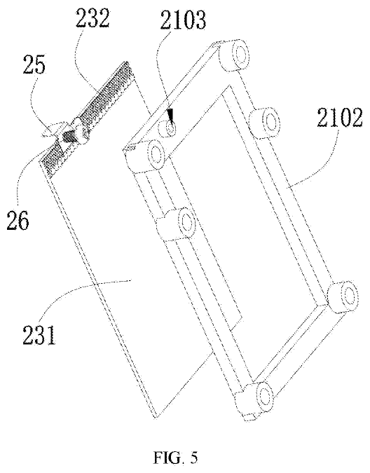

As shown in FIG. 2, FIG. 3, FIG. 4 and FIG. 5, the metal-air electrode component 20 comprises: a plastic bottom shell 21, a plastic surface shell 22, an air electrode 23, a metal electrode 24, a conductive sheet 25, and a first conductive bolt 26, a second conductive bolt 27, a first conductive elastic pin 28 and a second conductive elastic pin 29.

A hollow area 2101 is hollowed out at the position of the plastic bottom shell 21 corresponding to the air electrode 23, and the hollow area 2101 is used for mounting the air electrode 23.

The plastic surface shell 22 covers and cooperates with the front surface of the plastic bottom shell 21 to form an outer shell of the metal-air electrode component. Moreover, the plastic surface shell 22 is provided with a hollowed region 2201 at the position corresponding to the air electrode 23, and the hollowed region 2201 is used to penetrate air.

The metal electrode 24 and the air electrode 23 are respectively provided on the back surface and the front surface of the plastic bottom shell 21. In this embodiment, the metal electrode 24 is detachably fixed to the plastic bottom shell 21, and the periphery of the air electrode 23 is encapsulated in the hollow area 2101 of the plastic bottom shell 21, thereby sealing the hollow area 2101 of the plastic bottom shell 21.

In addition, a gap 2001 is formed between the metal electrode 24 and the plastic bottom shell 21, and the gap 2001 communicates with the hollow area 2101 of the plastic bottom shell 21. After the metal electrode 24 is immersed in the metal salt solution of the metal-air cell, the metal salt solution can pass through the gap 2001 and the hollow area 2101 in sequence to contact the inner side of the air electrode 23. Furthermore, air can also contact the outer side of the air electrode 23 through the hollow area 2201 in the plastic surface shell 22, so that the inner side of the air electrode 23 can contact the metal salt solution and the outer side of the air electrode 23 can contact the air.

In this embodiment, the air electrode 23 is encapsulated in the annular hollow area 2101 of the plastic bottom shell 21 through an injection molding process, that is, the periphery of the air electrode 23 is encapsulated in the plastic bottom shell 21 to form an injection molding edge sealing, thereby sealing the hollow area 2101. Particularly, a plastic middle frame 2102 for encapsulating the air electrode 23 is formed in the injection molding encapsulating process. The plastic middle frame 2102 and the plastic bottom shell 21 are integrated, and the shapes of the plastic middle frame 2102 and the air electrode 23 are substantially the same, so that the plastic middle frame 2102 and the plastic bottom shell 21 cooperate with each other to achieve the injection molding edge sealing structure of the air electrode 23.

The advantage of using an injection molding process to encapsulate the air electrode 23 is that: an injection molding edge sealing is formed on the periphery of the air electrode 23, which ensures that there is no liquid leakage gap between the air electrode 23 and the plastic bottom shell 21, and ensures that the metal salt solution will not leak, that is, ensures the sealing performance between the air electrode 23 and the plastic bottom shell 21, and compared with the fixing method using screws and other fixing parts, it has better sealing performance and product consistency, thereby reducing product defect rate and improving product performance.

In addition, the air electrode 23 comprises an air electrode body 231 and a conductive side 232 extending from the air electrode body 231. The metal-air electrode component further comprises a conductive sheet 25, which is in electric contact with the conductive side 232. In this embodiment, both the conductive side 232 and the conductive sheet 25 are encapsulated in the plastic bottom shell 21. That is, both the conductive side 232 and the conductive sheet 25 are fixed by injection molding through the plastic middle frame 2102.

In this embodiment, the first conductive bolt 26 extends into the plastic bottom shell 21 to be in electric contact with the conductive sheet 25; and the metal electrode 24 is fixed to the plastic bottom shell 21 through the second conductive bolt 27. It should be noted that the metal electrode 24 is detachably fixed to the plastic bottom shell 21 through the second conductive bolt 27, so that it is convenient for the user to replace the metal electrode 24.

In order to further improve the sealing performance, a sealing contact is formed between the first conductive bolt 26 and the hole wall of the mounting hole 2103 in the plastic bottom shell 21. Specifically, in the injection molding encapsulating process, the mounting hole 2103 is formed on the plastic middle frame 2102; after the air electrode 23 is encapsulated in the plastic bottom shell 21, the first conductive bolt 26 is screwed into the mounting hole 2103;

in order to ensure to have a good sealing performance after the first conductive bolt 26 is screwed into the mounting hole 2103, the diameter of the mounting hole 2103 is slightly smaller than the diameter of the first conductive bolt 26, so that a tight sealing contact is formed therebetween to achieve the purpose of sealing. It should be understood that the air electrode 23 provided in this embodiment uses a conductive bolt as a conductive member. Of course, it is not limited to this embodiment, and other suitable conductive members can also be used to conduct electricity, such as conductive elastic posts, conductive pillars, or conductive wires, which is not limited in the utility model.

In addition, the second conductive bolt 27 is sealed and fixed with the plastic bottom shell 21 through a plastic gasket. A plastic gasket is sleeved on the second conductive bolt 27, and the plastic gasket is used for sealing and fixing.

Therefore, the air electrode 23 in the metal-air electrode component provided by the utility model has a two-layer sealing structure:

a first layer of sealing structure: the periphery of the air electrode 23 is encapsulated in the hollow area 2101 of the plastic bottom shell 21 through an injection molding process;

a second layer of sealing structure: a sealing contact is formed between the first conductive bolt 26 and the hole wall of the mounting hole 2103 in the plastic bottom shell 21.

The cooperation of the two-layer sealing structure can ensure an excellent sealing effect between the air electrode 23 and the plastic bottom shell 21, reduce the possibility of solution leakage, and enable the metal-air electrode component to have higher reliability.

In addition, the first conductive elastic pin 28 and the second conductive elastic pin 29 are used as output electrodes, and both the first conductive elastic pin 28 and the second conductive elastic pin 29 extend out of the plastic surface shell 22. In this embodiment, the first conductive elastic pin 28 and the second conductive elastic pin 29 are electrically connected to the first conductive bolt 26 and the second conductive bolt 27 through conductive foam 30, respectively.

The processing process of the metal-air electrode component is as follows:

Step 1: the air electrode 23 is mounted in the hollow area 2101 of the plastic bottom shell 21, and the conductive sheet 25 is pressed against the conductive side 232 of the air electrode 23;

Step 2: the injection molding process is used to encapsulate the periphery of the air electrode 23 in the plastic bottom shell 21 to form an injection molding edge sealing structure of the air electrode 23, and the conductive sheet 25 is also encapsulated in the plastic bottom shell 21.

Step 3: the first conductive bolt 26 and the second conductive bolt 27 are mounted, respectively, the first conductive bolt 26 extends into the plastic bottom shell 21 to be in electric contact with the conductive sheet 25, and the metal electrode 24 is fixed to the plastic bottom shell 21 through the second conductive bolt 27;

Step 4: the conductive foam 30 is affixed, so that the first conductive elastic pin 28 and the second conductive elastic pin 29 are electrically connected to the first conductive bolt 26 and the second conductive bolt 27 through the conductive foam 30, respectively ;

Step 5: the plastic surface shell covers and is fixed to the front surface of the plastic bottom shell 21.

The above is only an embodiment of the utility model, rather than limit the patent scope of the utility model. Any equivalent structure or equivalent process transformation made using the contents of the specification of the utility model, which is directly or indirectly used in other related technical fields, is similarly included in the patent protection scope of the utility model.

What is claimed is:

1. A liquid-proof metal-air electrode component, comprising: a plastic bottom shell, an air electrode and a metal electrode, wherein the metal electrode and the air electrode are respectively provided on the back surface and the front surface of the plastic bottom shell, the metal electrode is fixed to the plastic bottom shell, and the periphery of the air electrode is encapsulated in the plastic bottom shell.

2. The liquid-proof metal-air electrode component according to claim 1, wherein the periphery of the air electrode is encapsulated in the plastic bottom shell through an injection molding process;
a plastic middle frame for encapsulating the air electrode is formed in the injection molding encapsulating process, the plastic middle frame and the plastic bottom shell are integrated, and the plastic middle frame and the plastic bottom shell cooperate with each other to achieve the injection molding edge sealing structure of the air electrode.

3. The liquid-proof metal-air electrode component according to claim 1, wherein the air electrode comprises an air electrode body and a conductive side extending from the air electrode body,
the metal-air electrode component further comprises a conductive sheet, which is in electric contact with the conductive side;
both the conductive side and the conductive sheet are encapsulated in the plastic bottom shell.

4. The liquid-proof metal-air electrode component according to claim 3, wherein the metal-air electrode component further comprises a first conductive bolt and a second conductive bolt, the first conductive bolt extends into the plastic bottom shell to be in electric contact with the conductive sheet; and the metal electrode is fixed to the plastic bottom shell through a second conductive bolt.

5. The liquid-proof metal-air electrode component according to claim 4, wherein a sealing contact is formed between the first conductive bolt and the hole wall of the mounting hole in the plastic bottom shell;
the second conductive bolt is sealed and fixed with the plastic bottom shell through a plastic gasket.

6. The liquid-proof metal-air electrode component according to claim 4, further comprising a first conductive elastic pin and a second conductive elastic pin used as output electrodes, respectively, wherein the first conductive elastic pin and the second conductive elastic pin are electrically connected to the first conductive bolt and the second conductive bolt through conductive foam, respectively.

7. The liquid-proof metal-air electrode component according to claim 6, further comprising a plastic surface shell, wherein the plastic surface shell covers the front surface of the plastic bottom shell,
the surface shell is provided with a hollow area at the position corresponding to the air electrode, and the first conductive elastic pin and the second conductive elastic pin extend out of the plastic surface shell.

8. A metal-air cell, comprising: a liquid container, and a metal-air electrode component mounted on the liquid container, wherein the metal-air electrode component is the liquid-proof metal-air electrode component according to claim 1,
after pouring the liquid into the liquid container, the metal electrode of the metal-air electrode component is immersed in the liquid of the liquid container.
